(19) United States
(12) Patent Application Publication
(10) Pub. No.: US 2012/0316809 A1
(43) Pub. Date: Dec. 13, 2012

(54) VIRTUAL OPTION BOARD FOR USE IN PERFORMING METERING OPERATIONS

(75) Inventors: William M. Egolf, Apex, NC (US); Vlad Pambucol, Raleigh, NC (US); Konstantin Lobastov, Raleigh, NC (US); Peter R. Rogers, Raleigh, NC (US)

(73) Assignee: ELSTER SOLUTIONS, LLC, Raleigh, NC (US)

(21) Appl. No.: 13/156,165

(22) Filed: Jun. 8, 2011

(51) Int. Cl. G06F 19/00

(52) U.S. Cl. 702/62; 702/61

(57) ABSTRACT

Methods, systems, and apparatus are provided for adding functionality to a metering device. A metering device may include a microcontroller (MCU) having separate blocks of memory for storing different types of data. The MCU may store main program code as firmware in one block of the flash memory, while also storing a virtual option board as firmware in a separate block of flash memory. The main program code may be used by the metering device to implement a base level of functionality in the metering device. The virtual option board may be used by the metering device to implement additional functionality. The functionality added by the virtual option board may include customer-specific metering operations and/or market-specific metering operations.

### FIELD OF THE INVENTION

The present invention relates to communications systems, and more particularly, to systems, methods, and apparatus for adding functionality to a metering device.

### BACKGROUND

A metering device may perform various metering operations for various customers and in various markets. As such, a metering device may need to implement different features depending on the customer or the market. To ensure that each metering device is able to implement the features for a given customer or market, various features may be added to the program memory of the metering device. Once the program memory space is filled, memory space may be increased and/or functionality may be sacrificed to add additional and/or different features to the metering device. After all of the metering features for various customers and markets have been stored in program memory, different features may be enabled and/or disabled.

For use in a given market, only a portion of the metering device's full capabilities may be enabled. For example, the metering device may be configured to support various protocols (e.g., communications protocols) that may be used in various markets and/or for various customers. While the metering device may support various protocols, the metering device may be configured to enable only the protocols to be used in a given market and/or metering application. This may result in wasted memory space and/or missed opportunities.

To configure a metering device for certain metering operations, physical option boards have been implemented to add various features to the metering devices in which the physical option board(s) may be installed. For example, the physical option board may be a physical module that plugs into a system bus on the metering device to add different communication protocols or other functionality to the metering device. Having the physical option board as a separate board in the meter may be convenient for configuration of the metering device, but is cost-prohibitive in the marketplace.

There is, therefore, a need to configure a metering device for certain metering operations in a convenient and cost-efficient manner.

### SUMMARY OF THE INVENTION

Various techniques for adding functionality to a metering device are disclosed herein. The metering device may include a microcontroller that includes blocks of flash memory for storing a virtual option board on the metering device. A main program code may be stored as firmware in at least one block of the flash memory in the microcontroller of the metering device. The main program code may be configured to implement a base level of functionality in the meter. Based on a selection of desired additional functionality, a virtual option board may be stored as firmware in another block of the flash memory in the microcontroller of the metering device. The virtual option board may comprise firmware or other program code that virtually implements a function of an option board. The virtual option board may also be stored without changing the main program code of the metering device. Once the main program code and the virtual option board have been stored on the metering device, metering operations may be performed on the metering device according to the main program code and the virtual option board. The metering operations may be performed by accessing the main program code directly from one block of the flash memory in the microcontroller and accessing the virtual option board from another block of flash memory via an application program interface.

According to another embodiment, a metering device is described herein that includes a microcontroller and blocks of flash memory. The microcontroller may be configured to perform metering operations on the metering device according to a main program code and a virtual option board. A first block of flash memory may be stored in the microcontroller and the main program code may be stored as firmware therein. The main program code may be configured to implement a base level of functionality in the meter. A second block of flash memory may also be stored in the microcontroller. The virtual option board may be stored as firmware in the second block of the flash memory. The virtual option board may virtually implement a function of an option board and may be stored without changing the main program code of the metering device. The microcontroller may be further configured to access the virtual option board via an application program interface.

Other features and aspects of the methods, systems and apparatus described herein will become apparent from the following detailed description and the associated drawings.

### BRIEF DESCRIPTION OF THE DRAWINGS

The foregoing summary, as well as the following detailed description, is better understood when read in conjunction with the appended drawings. For the purpose of illustrating the method and apparatus described herein, there is shown in the drawings exemplary embodiments; however, the invention is not limited to the specific methods and instrumentalities disclosed. In the drawings:

FIG. 1 is a diagram of an exemplary metering communication system employing wireless networking;

FIG. 2 expands upon the diagram of FIG. 1 and illustrates the exemplary metering communication system in greater detail;

FIG. 3A is a block diagram illustrating an exemplary gatekeeper (also referred to as a “collector”) of the metering communication system of FIG. 1;

FIG. 3B is a block diagram illustrating an exemplary metering device of the metering communication system of FIG. 1;

FIG. 3C illustrates one embodiment of an outbound data packet format of the metering communication system illustrated in FIGS. 1, 2, 3A and 3B, and FIG. 3D illustrates one embodiment of an inbound data packet format;

FIG. 4 is a flow diagram illustrating a process for installing a virtual option board on a metering device;

FIG. 5 is a flow diagram illustrating another process for installing a virtual option board on a metering device;

FIG. 6 is a block diagram illustrating an interaction between a main program and a virtual option board; and

FIG. 7 is a diagram illustrating an exemplary process for installing a virtual option board.

### DETAILED DESCRIPTION

The systems, methods, and apparatus described herein enable metering devices in a utility system to include additional functionality for performing metering operations. For example, the metering device may include a microcontroller that includes blocks of flash memory to incorporate a virtual option board on the metering device. A main program code may be stored as firmware in at least one block of the flash memory in the microcontroller of the metering device. The main program code may be configured to implement a base level of functionality in the meter. Based on a selection of desired additional functionality, a virtual option board may be stored as firmware in another block of the flash memory in the microcontroller of the metering device. The virtual option board may virtually implement a function of an option board. The virtual option board may also be stored without changing the main program code of the metering device. Once the main program code and the virtual option board have been stored on the metering device, metering operations may be performed on the metering device according to the main program code and the virtual option board. The metering operations may be performed by accessing the main program code directly from one block of the flash memory in the microcontroller and accessing the virtual option board from another block of flash memory via an application program interface.

According to another example, a metering device is described herein that includes a microcontroller and blocks of flash memory. The microcontroller may be configured to perform metering operations on the metering device according to a main program code and a virtual option board. A first block of flash memory may be stored in the microcontroller and the main program code may be stored as firmware therein. The main program code may be configured to implement a base level of functionality in the meter. A second block of flash memory may also be stored in the microcontroller. The virtual option board may be stored as firmware in the second block of the flash memory. The virtual option board may virtually implement a function of an option board and may be stored without changing the main program code of the metering device. The microcontroller may be further configured to access the virtual option board via an application program interface.

Exemplary embodiments of these systems, methods and apparatus are provided below, but it is understood that the invention is not limited to those specific embodiments. While certain details have been provided to illustrate the embodiments described below, it is understood that the invention may be practiced without those specific details. Acronyms and other terms may be used in the following description, however they are not intended to limit the scope of the invention as defined by the appended claims.

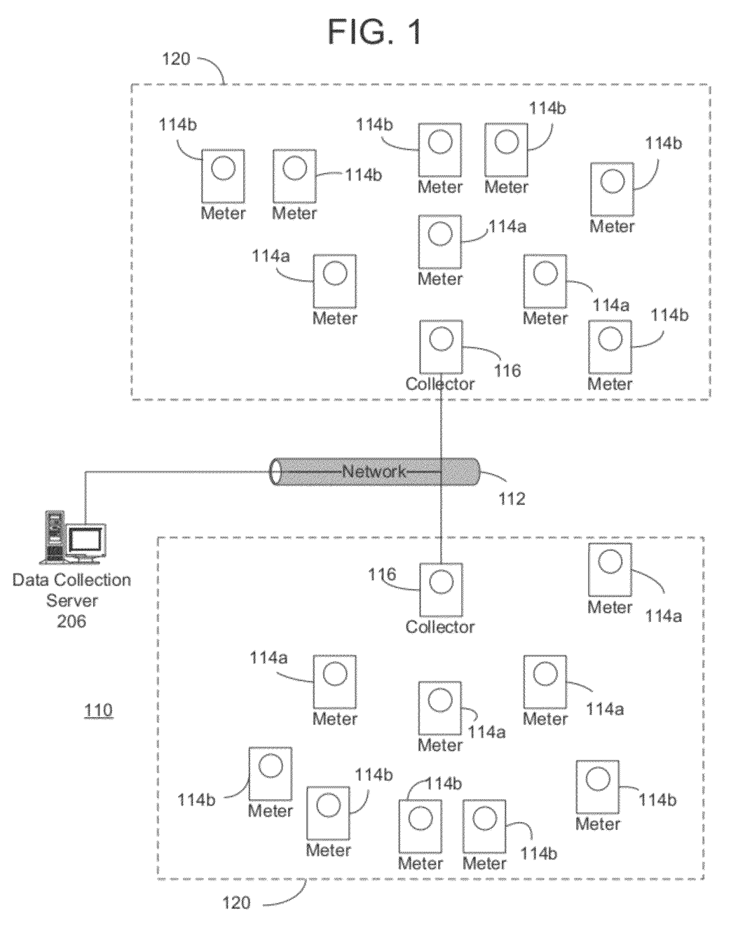

One example of a metering system 110 in which the systems, methods and apparatus described herein may be employed is illustrated in FIGS. 1, 2 and 3A-D. The description given herein with respect to those figures is for exemplary purposes only and is not intended in any way to limit the scope of potential embodiments.

System 110 comprises a plurality of metering devices, or “meters” 114, which are operable to sense and record consumption or usage of a service or commodity such as, for example, electricity, water, or gas. Meters 114 may be located at customer premises such as, for example, a home or place of business. Meters 114 comprise circuitry for measuring the consumption of the service or commodity being consumed at their respective locations and for generating data reflecting the consumption, as well as other data related thereto. Meters 114 may also comprise circuitry for wirelessly transmitting data generated by the meter to a remote location. Meters 114 may further comprise circuitry for receiving data, commands or instructions wirelessly as well. Meters that are operable to both receive and transmit data may be referred to as “bi-directional” or “two-way” meters (or nodes), while meters that are only capable of transmitting data may be referred to as “transmit-only” or “one-way” meters. In bi-directional meters, the circuitry for transmitting and receiving may comprise a transceiver. In an illustrative embodiment, meters 114 may be, for example, electricity meters manufactured by Elster Solutions, LLC and marketed under the trade name REX.

System 110 further comprises collectors 116. In one embodiment, collectors 116 are also meters operable to detect and record usage of a service or commodity such as, for example, electricity, water, or gas. In addition, collectors 116 are operable to send data to and receive data from meters 114. Thus, like the meters 114, the collectors 116 may comprise both circuitry for measuring the consumption of a service or commodity and for generating data reflecting the consumption and circuitry for transmitting and receiving data. In one embodiment, collector 116 and meters 114 communicate with and amongst one another using any one of several wireless techniques such as, for example, frequency hopping spread spectrum (FHSS) or direct sequence spread spectrum (DSSS). Collectors 116 are also sometimes referred to as “gatekeepers.”

A collector 116 and the meters 114 with which it communicates define a subnet or local area network (LAN) 120 of system 110. In one embodiment, each subnet or LAN may define a controlled, wireless mesh network with the collector 116 (gatekeeper) of that LAN effectively controlling the mesh network. Further details of how such a LAN is initialized, defined and maintained are described hereinafter.

As used herein, a collector 116 and the meters 114 with which it communicates may be referred to as “nodes” in the subnet/LAN 120. In each subnet/LAN 120, each meter transmits data related to consumption of the commodity being metered at the meter's location. The collector 116 receives the data transmitted by each meter 114, effectively “collecting” it, and then periodically transmits the data from all of the meters in the subnet/LAN 120 to a data collection server 206. The data collection server 206 stores the data for analysis and preparation of bills, for example. The data collection server 206 may be a specially programmed general purpose computing system and may communicate with collectors 116 via a network 112. The network 112 may comprise any form of network, including a wireless network or a fixed-wire network, such as a local area network (LAN), a wide area network (WAN), the Internet, an intranet, a telephone network, such as the public switched telephone network (PSTN), a Frequency Hopping Spread Spectrum (FHSS) radio network, a mesh network, a Wi-Fi (802.11) network, a Wi-Max (802.16) network, a land line (POTS) network, a TCP/IP network, a W-WAN, a GPRS network, a CDMA network, a Fiber network, or any combination of the above.

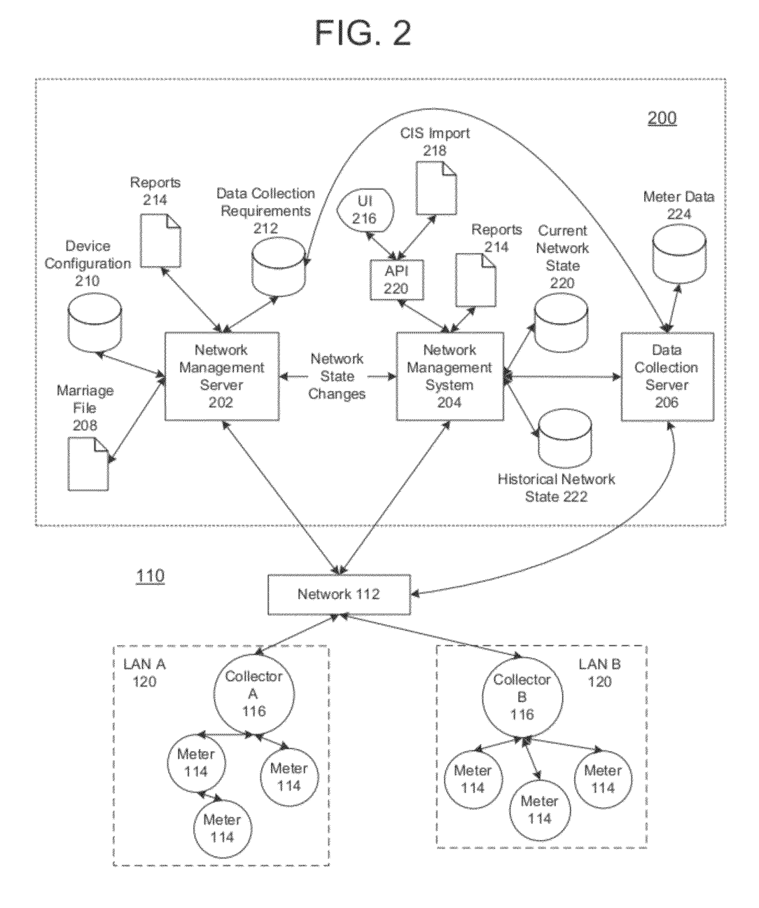

Referring now to FIG. 2, further details of the metering communication system 110 are shown. Typically, the system will be operated by a utility company or a company providing information technology services to a utility company. In FIG. 2, some or all of the components illustrated in dashed-box 200 may be referred to a utility's “operations center,” “head-end,” or similar name. As shown, the operations center 200 may comprise a network management server 202, a network management system (NMS) 204 and the data collection server 206 that together manage one or more subnets/LANs 120 and their constituent nodes. The NMS 204 tracks changes in network state, such as new nodes registering/unregistering with the system 110, node communication paths changing, etc. This information is collected for each subnet/LAN 120 and is detected and forwarded to the network management server 202 and data collection server 206.

Each of the meters 114 and collectors 116 is assigned an identifier (LAN ID) that uniquely identifies that meter or collector on its subnet/LAN 120. In this embodiment, communication between nodes (i.e., the collectors and meters) and the communication system 110 is accomplished using the LAN ID. However, it is preferable for operators of a utility to query and communicate with the nodes using their own identifiers. To this end, a marriage file 208 may be used to correlate a utility's identifier for a node (e.g., a utility serial number) with both a manufacturer serial number (i.e., a serial number assigned by the manufacturer of the meter) and the LAN ID for each node in the subnet/LAN 120. In this manner, the utility can refer to the meters and collectors by the utilities identifier, while the system can employ the LAN ID for the purpose of designating particular meters during system communications.

A device configuration database 210 stores configuration information regarding the nodes. For example, in the metering communication system 110, the device configuration database may include data regarding time of use (TOU) switchpoints, etc. for the meters 114 and collectors 116 communicating in the system 110. A data collection requirements database 212 contains information regarding the data to be collected on a per node basis. For example, a utility may specify that metering data such as load profile, demand, TOU, etc. is to be collected from particular meter(s) 114a. Reports 214 containing information on the network configuration may be automatically generated or in accordance with a utility request.

The network management system (NMS) 204 maintains a database describing the current state of the global fixed network system (current network state 220) and a database describing the historical state of the system (historical network state 222). The current network state 220 contains data regarding current meter-to-collector assignments, etc. for each subnet/LAN 120. The historical network state 222 is a database from which the state of the network at a particular point in the past can be reconstructed. The NMS 204 is responsible for, amongst other things, providing reports 214 about the state of the network. The NMS 204 may be accessed via an API 220 that is exposed to a user interface 216 and a Customer Information System (CIS) 218. Other external interfaces may also be implemented. In addition, the data collection requirements stored in the database 212 may be set via the user interface 216 or CIS 218.

The data collection server 206 collects data from the nodes (e.g., collectors 116) and stores the data in a database 224. The data includes metering information, such as energy consumption, and may be used for billing purposes, etc. by a utility provider.

The network management server 202, network management system 204 and data collection server 206 communicate with the nodes in each subnet/LAN 120 via network 112.

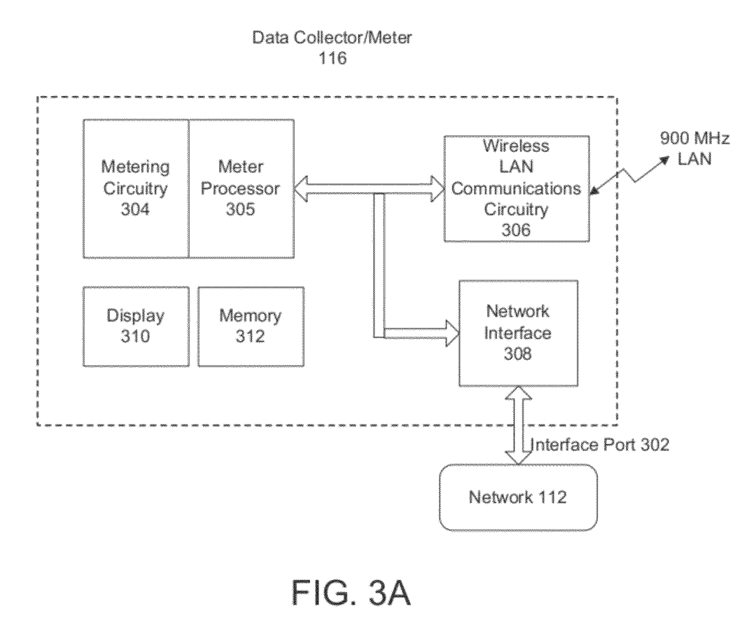

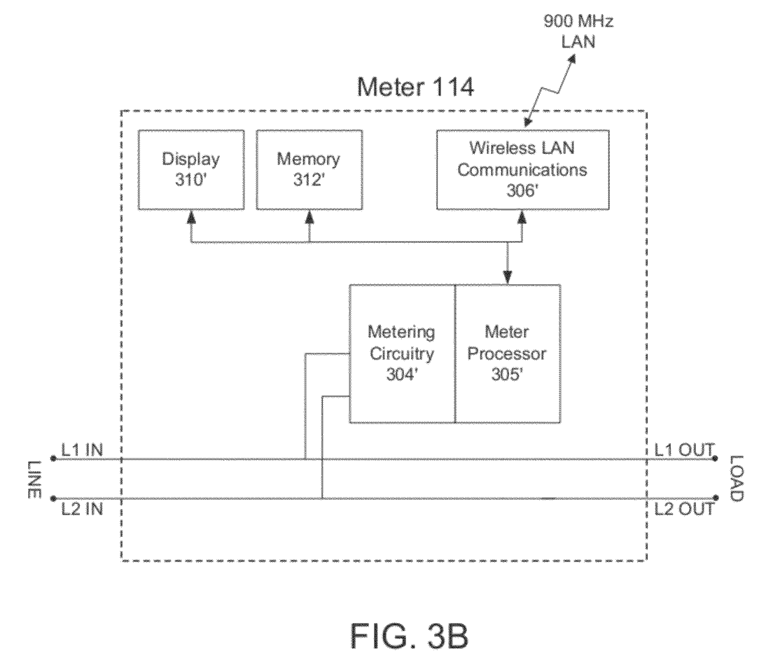

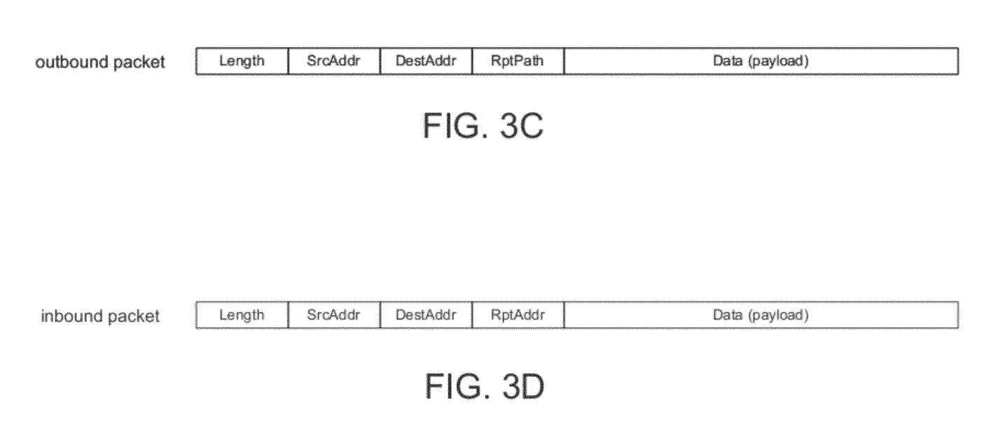

FIG. 3A is a block diagram illustrating further details of one embodiment of a collector 116. Although certain components are designated and discussed with reference to FIG. 3A, it should be appreciated that such designations and discussion are not limiting. In fact, various other components typically found in an electronic meter may be a part of collector 116, but have not been shown in FIG. 3A for the purposes of clarity and brevity. Also, other components may be used to accomplish the operation of collector 116. The components that are shown and the functionality described for collector 116 are provided as examples, and are not meant to be exclusive of other components or other functionality.

As shown in FIG. 3A, collector 116 may comprise metering circuitry 304 that performs measurement of consumption of a service or commodity and a processor 305 that controls the overall operation of the metering functions of the collector 116. According to one example, the meter processor 305 may include a microcontroller (MCU) or similar processing module. The collector 116 may further comprise a display 310 for displaying information such as measured quantities and meter status and a memory 312 for storing data. The memory 312 may include volatile and/or non-volatile memory, such as EEPROM and/or flash memory for example. The memory 312 may be stored in and/or external to the meter processor 305. The collector 116 further comprises wireless LAN communications circuitry 306 for communicating wirelessly with the meters 114 in a subnet/LAN and a network interface 308 for communication over the network 112.

In one embodiment, the metering circuitry 304, processor 305, display 310 and memory 312 are implemented using an A3 ALPHA meter available from Elster Solutions, LLC. In that embodiment, the wireless LAN communications circuitry 306 may be implemented by a LAN Option Board (e.g., a 900 MHz two-way radio) installed within the A3 ALPHA meter, and the network interface 308 may be implemented by a WAN Option Board (e.g., a telephone modem) also installed within the A3 ALPHA meter. In this embodiment, the WAN Option Board 308 routes messages from network 112 (via interface port 302) to either the meter processor 305 or the LAN Option Board 306. LAN Option Board 306 may use a transceiver (not shown), for example a 900 MHz radio, to communicate data to meters 114. Also, LAN Option Board 306 may have sufficient memory to store data received from meters 114. This data may include, but is not limited to the following: current billing data (e.g., the present values stored and displayed by meters 114), previous billing period data, previous season data, and load profile data.

LAN Option Board 306 may be capable of synchronizing its time to a real time clock (not shown) in A3 ALPHA meter, thereby synchronizing the LAN reference time to the time in the meter. The processing necessary to carry out the communication functionality and the collection and storage of metering data of the collector 116 may be handled by the processor 305 and/or additional processors (not shown) in the LAN Option Board 306 and the WAN Option Board 308.

The responsibility of a collector 116 is wide and varied. Generally, collector 116 is responsible for managing, processing and routing data communicated between the collector and network 112 and between the collector and meters 114. Collector 116 may continually or intermittently read the current data from meters 114 and store the data in a database (not shown) in collector 116. Such current data may include but is not limited to the total kWh usage, the Time-Of-Use (TOU) kWh usage, peak kW demand, and other energy consumption measurements and status information. Collector 116 also may read and store previous billing and previous season data from meters 114 and store the data in the database in collector 116. The database may be implemented as one or more tables of data within the collector 116.

In one embodiment, the LAN Option Board 306 employs a CC1110 chip available from Texas Instruments, Inc. to implement its wireless transceiver functionality. The CC1110 chip has a built-in Received Signal Strength Indication (RSSI) capability that provides a measurement of the power present in a received radio signal.

FIG. 3B is a block diagram of an exemplary embodiment of a meter 114 that may operate in the system 110 of FIGS. 1 and 2. As shown, the meter 114 comprises metering circuitry 304′ for measuring the amount of a service or commodity that is consumed and a processor 305′ that controls the overall functions of the meter. According to one example, the processor 305′ may include a microcontroller (MCU) or similar processing module. The meter 114 also includes a display 310′ for displaying meter data and status information and a memory 312′ for storing data and program instructions. The memory 312′ may include volatile and/or non-volatile memory, such as EEPROM and/or flash memory for example. The memory 312′ may be stored in and/or external to the meter processor 305′. The meter 114 further comprises wireless communications circuitry 306′ for transmitting and receiving data to/from other meters 114 or a collector 116. The wireless communication circuitry 306′ may comprise, for example, the aforementioned CC1110 chip available from Texas Instruments, Inc.

At some point, each meter will have an established communication path to the collector which will be either a direct path (i.e., level one nodes) or an indirect path through one or more intermediate nodes that serve as repeaters. If during operation of the network, a meter registered in this manner fails to perform adequately, it may be assigned a different path or possibly to a different collector as described below.

Once a communication path between the collector and a meter is established, the meter can begin transmitting its meter data to the collector and the collector can transmit data and instructions to the meter. Data transmission between a collector and the meters in its subnet are, in one embodiment, performed in accordance with the following communications protocol. In this protocol, data is transmitted in packets. “Outbound” packets are packets transmitted from the collector to a meter at a given level. In one embodiment, as illustrated in FIG. 3C, outbound packets contain the following fields, but other fields may also be included:
Length—the length of the packet;
SrcAddr—source address—in this case, the LAN ID of the collector;
DestAddr—the LAN ID of the meter to which the packet is addressed;
RptPath—the communication path to the destination meter (i.e., the list of identifiers of each repeater in the path from the collector to the destination node); and
Data—the payload of the packet.
   The packet may also include integrity check information (e.g., CRC), a pad to fill-out unused portions of the packet and other control information. When the packet is transmitted from the collector, it will only be forwarded on to the destination meter by those repeater meters whose identifiers appear in the RptPath field. Other meters may receive the packet, but meters that are not listed in the path identified in the RptPath field will not repeat the packet.

“Inbound” packets are packets transmitted from a meter at a given level to the collector. In one embodiment, as illustrated in FIG. 3D, inbound packets contain the following fields, but other fields may also be included:
Length—the length of the packet;
SrcAddr—source address—the LAN ID of the meter that initiated the packet;
DestAddr—the LAN ID of the collector to which the packet is to be transmitted;
RptAddr—an identifier of the parent node that serves as the next repeater for the sending node;
Data—the payload of the packet;
   Because each meter knows the identifier of its parent node (i.e., the node in the next lower level that serves as a repeater for the present node), an inbound packet need only identify who is the next parent. When a node receives an inbound packet, it checks to see if the RptAddr matches its own identifier. If not, it discards the packet. If so, it knows that it is supposed to forward the packet on toward the collector. The node will then replace the RptAddr field with the identifier of its own parent and will then transmit the packet so that its parent will receive it. This process will continue through each repeater at each successive level until the packet reaches the collector.

The functionality of the metering devices described herein (e.g., a meter or a collector) may be stored in program memory (e.g., volatile or non-volatile memory). For example, the functionality may be stored in non-volatile memory associated with a microcontroller (MCU) on the metering device, such as EEPROM or flash memory for example. The functionality of the metering device may be easily updated by updating the program memory.

According to an embodiment, the metering device may be customized to correspond to a given market and/or customer request. For example, the metering device may be customized by downloading a virtual option board. The virtual option board may implement different features on the metering device. For example, the virtual option board may be configured to implement features and/or metering applications that correspond to a given market and/or customer request. The virtual option board may be developed, added to, and/or implemented on the metering device without impacting a main program code stored on the metering device for performing a base level of metering operations.

The virtual option board may be stored on the metering device as firmware (e.g., static flash memory) in the meter's microcontroller (MCU). The MCU of the metering device may allow firmware to be flashed as one block of memory, or it may allow firmware to be flashed in separate sections of memory. The MCU may enable the use of flash to store program memory and configuration data in separate sections of memory within the MCU. The portion of the memory in the MCU that may be used for storing configuration data may also be used for storing additional firmware, such as program code or a virtual option board for example. For example, a section of flash memory may be used to store the main program code as firmware for performing a base level of metering operations on the metering device. Additionally, a section of flash memory may be set aside to hold a virtual option board, that is not stored as configuration data, but instead as actual firmware code. By compartmentalizing the main program and the virtual option board, development and/or testing may be simplified.

The MCU may execute a main program to perform metering operations. For example, the main program may use the main program code to perform a base level of metering operations. At a certain point in the main program code, the main program may jump to an address within the firmware (i.e., program code) of a virtual option board, execute code within the virtual option board to implement additional features, and return to the main program code for continued execution. The additional features implemented using the virtual option board may be of a wide variety of desirable features, including without limitation additional protocols (e.g., communication protocols). Each virtual option board may correspond to a given market and/or customer request. The virtual option board, and/or features included therein, may be added to the metering device without impacting the main firmware stored on the metering device.

According to an embodiment, the virtual option board may be “plugged in” (e.g., installed) during initial manufacturing. For example, during the manufacturing process, a manufacturing system may check the customer-specific requests and/or download a virtual option board to the metering device that adds a particular feature or set of features to the metering device that correspond to the customer and/or market in which the customer is participating. In one implementation, the virtual option board may be loaded when the metering device's MCU ROM is programmed (e.g., flash programmed). The virtual option board that is stored during manufacture may be a customized or a default virtual option board.

According to an embodiment, the virtual option board may be added and/or updated after the metering device has been installed in the field. For example, the virtual option board may be added via a field upgrade tool. In one implementation, the metering device's MCU ROM may be initially programmed with a default virtual option board or no virtual option board at all. The virtual option board may then be loaded and/or upgraded at a later point in time. For example, a field upgrade tool may provided to a customer to download a virtual option board to the metering device that adds a particular feature or set of features to the metering device that correspond to the customer and/or market in which the customer is participating. The field upgrade tool may remotely communicate with the meter to download a virtual option board using the meter's existing wireless communications circuitry (e.g., circuitry 306′ in FIG. 3B) or via an optical port (not shown) on the meter. Alternatively, the virtual option board may be downloaded to the meter from a gateway or other “head-end” device or computer via a wireless LAN to which the meter is connected.

The virtual option board may be created by the manufacturer of the virtual option board and/or a third party developer. For example, the third party developer may be a developer of Automatic Meter Reading (AMR) modules that creates a virtual option board for adding functionality to the metering device. In implementing the virtual option board, a physical option board may also be included that comprises additional hardware needed to implement the functions of the virtual option board, such as a power supply, radio frequency (RF) components, and/or an antenna for example. The virtual option board may enable a physical option board to include less hardware and/or software for performing communications and/or other metering operations.

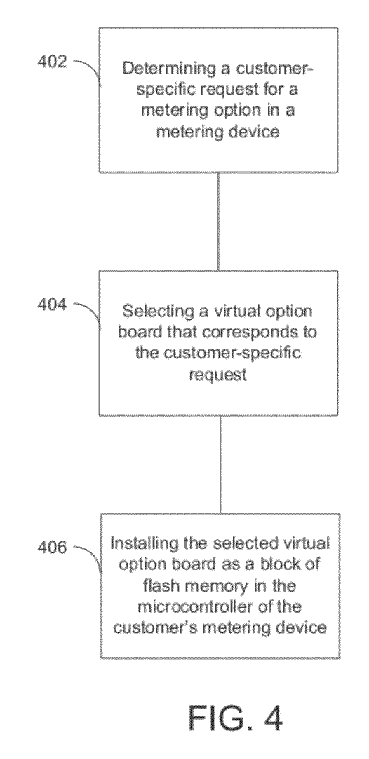

FIG. 4 is a flow diagram illustrating a process for installing a virtual option board on a metering device that corresponds to a customer-specific request. As illustrated in FIG. 4, a customer-specific request may be determined for a metering option in the customer's metering device at 402. The customer-specific request may include any metering request that a customer may have for performing metering operations on a metering device. For example, the customer-specific metering request may include a request for a certain protocol to be installed on the metering device. At 404 a virtual option board may be selected that corresponds to the customer-specific request. For example, a virtual option board may be selected that includes a protocol requested by the customer. At 406, the selected virtual option board may be installed on the metering device. The virtual option board may be stored as a block of flash memory in the microcontroller of the customer's metering device, as described herein.

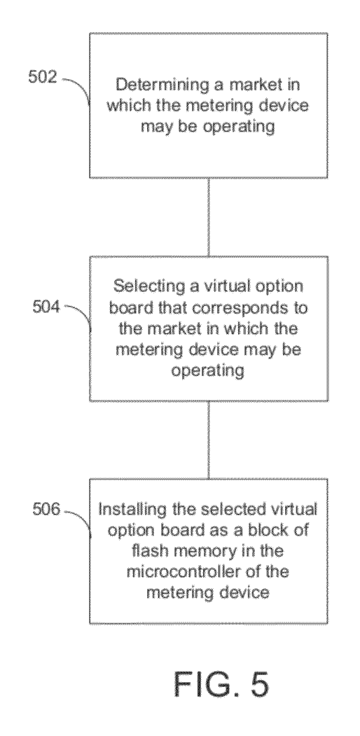

FIG. 5 is a flow diagram illustrating a process for installing a virtual option board on a metering device that corresponds to a market in which the metering device may be operating. As illustrated in FIG. 5, at 502, a market may be determined in which the metering device may be currently operating or expected to be operating in the future. At 504 a virtual option board may be selected that corresponds to the determined market. For example, a virtual option board may be selected that includes a communication protocol for implementing the metering device in a given market. At 506, the selected virtual option board may be installed on the metering device. The virtual option board may be stored as a block of flash memory in the microcontroller of the customer's metering device, as described herein.

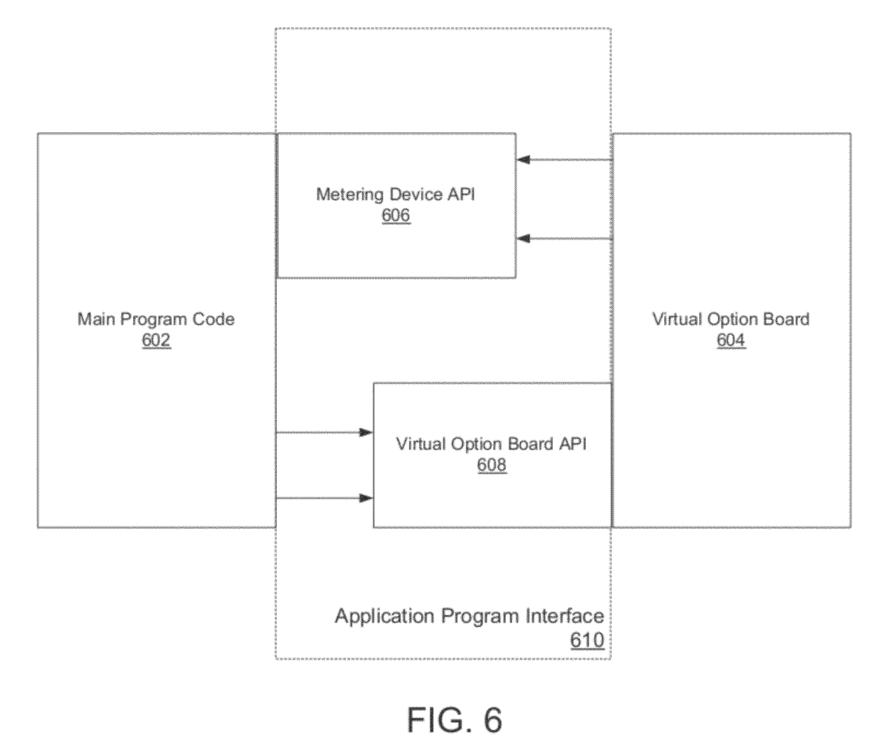

The virtual option board may be implemented using an Application Program Interface (API). For example, the API may allow a main program executing on the metering device to interact with the virtual option board to perform metering operations. FIG. 6 is a block diagram illustrating interactions between the main program and the virtual option board. As illustrated in FIG. 6, the main program code 602 may be stored separately from the virtual option board 604. The MCU may execute the main program code 602 and, at a certain point in the main program code, the MCU may switch control to the code of the virtual option board 604 to implement additional features on the metering device provided by the virtual option board. The main program code 602 may access the virtual option board 604 using a virtual option board API 608. The virtual option board API 608 may be a part of the Application Program Interface (API) 610. The additional features may be implemented by executing the code of the virtual option board 604. The code and/or data of the virtual option board 604 may be communicated to the main program code 602 using a metering device API 606. The metering device API 606 may also be a part of the API 610. Once the MCU executes the additional features implemented by the code of the virtual option board 604, program execution may switch back to the main program code 602 to continue performing metering operations implemented by the main program code 602.

Through the API 610, the main program 602 may become aware of the presence of the virtual option board 604, validate the integrity of the virtual option board 604, and/or interact with the virtual option board 604. For example, the main program 602 may become aware of the presence of the virtual option board 604 when it is installed (e.g., written to the MCU's flash memory). After the installation is complete (e.g., when the flash operation completes), the main program 602 may verify the integrity and/or compatibility of the virtual option board 604. In an exemplary embodiment, an integrity check may verify a cyclic redundancy check (CRC) appended to the virtual option board's ROM image. If the CRC is correct, header data may be checked to confirm that the virtual option board 604 is compatible with the main program 602. After the virtual option board 604 is determined to be legitimate, control may be passed to it via the meter's API. The meter firmware may be built upon a multi-threaded, multi-tasking real-time operating system (RTOS) that facilitates task execution and/or messaging between tasks.

The main program 602 may interact with the virtual option board 604 using a scheme that shares, monitors, and/or controls the virtual option board's use of on-board resources, such as communication ports, LCD display, buttons, and/or memory access for example. The API 610 may allow the virtual option board to handle communication using its assigned serial port(s) or the like.

The virtual option board 604 may be developed, compiled, and/or linked separately from the main program 602. The virtual option board may know nothing about relocatable symbols (e.g., data, function addresses, etc.) that may belong to the main program 602. The main program 602 may have direct or indirect access to the virtual option board's 604 memory. For example, if the main program 602 does not have direct access to the virtual option board's 604 memory, the interface between the virtual option board and the main program may be defined by the API 610.

The metering device's main firmware program may become aware of the virtual option board (e.g., when the virtual option board is installed and/or after it has been flashed) through a header information block. The header information block may be located at the top of the virtual option board program information for example. A two-byte cyclic redundancy check (CRC) may validate the header data. The header data may include the size of the virtual option board (e.g., in bytes), addresses of the virtual option board's subroutines (e.g., initialization task, main task, and/or periodic task), memory requirements, and/or various other parameters corresponding to the virtual option board for example.

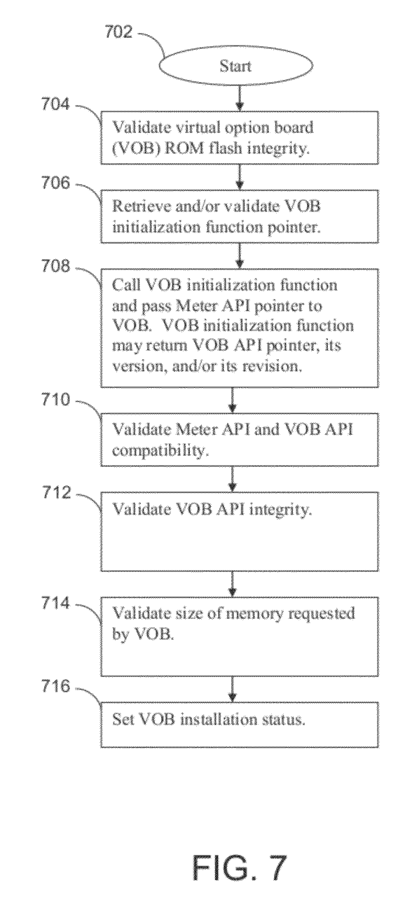

FIG. 7 is a diagram illustrating an exemplary process for installing a virtual option board. According to one embodiment, this installation process may be performed on a metering device during manufacture and/or after installation in the field. The installation process may begin at 702, which may initiate a process for validating the integrity of the virtual option board at 704. For example, the virtual option board's ROM flash integrity may be validated. At 706, the virtual option board's initialization function pointer may be retrieved and/or validated. At 708, the virtual option board's initialization function may be called. The virtual option board's initialization function may pass the meter API pointer to the virtual option board. The virtual option board initialization function may also return the virtual option board API pointer, its version, and/or revision. At 710, the compatibility of the meter API and the virtual option board API may be validated. For example, the compatibility of the version of the meter API and the version of the virtual option board API may be validated. The integrity of the virtual option board API may be validated at 712. This validation may include determining that the virtual option board API function pointers have an address within the virtual option board ROM space for example. At 714, the size of memory (e.g., RAM, EEPROM, or registered memory) requested by the virtual option board may be validated. At 716, the virtual option board may be installed in a metering device and/or the virtual option board installation status may be set.

Described herein are examples of meter API functions. Meter API functions may include serial communication interface functions, timer functions, and/or other functions used by the main program and/or virtual option board. Table 1 illustrates examples of serial communication interface functions. The serial communication interface functions may be provided by the meter's main program for use by the virtual option board.

TABLE 1
Serial Communication Interface Functions

| API Function Name | Description |
|---|---|
| MeterApi_reOpenPort | Opens a serial port for |
| | communication |
| MeterApi_getBaud | Returns current port baud rate |
| MeterApi_setBaud | Sets port baud rate |
| MeterApi_putChar | Writes a byte to the specified |
| | port's buffer |
| MeterApi_getChar | Returns a byte from the specified |
| | port's buffer |
| MeterApi_peek | Returns data from the specified |
| | port's buffer without removing it |
| | from the buffer |
| MeterApi_isTxBufferEmpty | Returns TRUE if the specified |
| | port's transmit buffer is empty |
| MeterApi_getNumBytesInRxBuffer | Returns number of bytes currently |
| | in specified port's receive buffer |
| MeterApi_flushRxBuffer | Flushes (e.g., empties) the |
| | specified port's receive buffer |
| MeterApi_flushTxBuffer | Flushes (e.g., empties) the |
| | specified port's transmit buffer |

Table 2 illustrates exemplary implementations of timer functions. The timer functions may be provided by the meter's main program for use by the virtual option board.

TABLE 2
Timer Functions

| API Function Name | Description |
|---|---|
| MeterApi_createTimer | Creates a hardware or software timer |
| MeterApi_setHwTimerUnits | Sets hardware timer units (e.g., seconds, |
| | milliseconds, microseconds, etc.) |
| MeterApi_setTimerUnits | Sets software timer units (e.g., seconds, |
| | milliseconds, microseconds, etc.) |
| MeterApi_loadTimer | Loads a countdown value into specified |
| | timer |
| MeterApi_startTimer | Starts specified timer |
| MeterApi_stopTimer | Stops specified timer |
| MeterApi_isTimerRunning | Returns TRUE if specified timer is |
| | currently running |
| MeterApi_killTimer | Frees the specified timer |
| MeterApi_killAllTimers | Frees timers currently assigned to virtual |
| | option board |

Before executing the code on the virtual option board, the integrity of the virtual option board may be checked, as described herein for example. After assuring the virtual option board's data integrity, the metering device's main program may execute the virtual option board's initialization task, to which it may pass data describing the main meter firmware. The data describing the main meter firmware may include the address and size of RAM allocated to the virtual option board, the address and size of the EEPROM allocated to the virtual option board, and/or various other parameters corresponding to the virtual option board for example.

The use of the virtual option board may create flexibility and/or efficient use of the limited memory available in an MCU. A different virtual option board may be developed to add different protocols and/or features. In one exemplary embodiment, meters that may be configured for use in China may have stored thereon a virtual option board that implements a Chinese protocol (e.g., DL/T 645). According to another exemplary embodiment, a metering device that may be configured for use in Russia may have a virtual option board that implements a Russian communications protocol, but the Russian market may not have an interest in the Chinese protocol. The use of the virtual option board, as described herein, may avoid having an unused and/or unnecessary feature stored in the firmware flash memory that is disabled because it is not being used.

All or portions of the systems, methods, and apparatus described above may be embodied in hardware, software, or a combination of both. When embodied in software, the methods and apparatus of the present invention, or certain aspects or portions thereof, may be embodied in the form of program code (i.e., computer executable instructions). This program code may be stored on a computer-readable medium, such as a magnetic, electrical, or optical storage medium, including without limitation, a floppy diskette, CD-ROM, CD-RW, DVD-ROM, DVD-RAM, magnetic tape, flash memory, hard disk drive, or any other machine-readable storage medium, wherein, when the program code is loaded into and executed by a machine, such as a computer or server, the machine becomes an apparatus for practicing the invention. A device on which the program code executes, such as meter 114 and/or collector 116 will generally include a processor, a storage medium readable by the processor (including volatile and non-volatile memory and/or storage elements), at least one input device, and at least one output device. The program code may be implemented in a high level procedural or object oriented programming language. Alternatively, the program code may be implemented in an assembly or machine language. In any case, the language may be a compiled or interpreted language. When implemented on a general-purpose processor, the program code may combine with the processor to provide a unique apparatus that operates analogously to specific logic circuits.

While systems, methods, and apparatus have been described and illustrated with reference to specific embodiments, those skilled in the art will recognize that modifications and variations may be made without departing from the principles described above and set forth in the following claims. For example, although in the embodiments described above, the systems and methods of the present invention are described in the context of a network of metering devices, such as electricity, gas, or water meters, it is understood that the present invention can be implemented in any kind of network. Also, while the exemplary metering system described above is a fixed network, the present invention can also be employed in mobile (walk by/drive by) systems. Accordingly, reference should be made to the following claims as describing the scope of the present invention.

What is claimed is:

1. A method for adding functionality to a metering device, wherein the metering device includes a microcontroller comprising blocks of flash memory for storing a virtual option board on the metering device, the method comprising:
storing a main program code as firmware in at least one block of the flash memory in the microcontroller of the metering device, wherein the main program code is configured to implement a base level of functionality in the metering device;
based on a selection of desired additional functionality, storing the virtual option board as firmware in at least one other block of the flash memory in the microcontroller of the metering device, wherein the virtual option board virtually implements a function of an option board, and wherein the virtual option board is stored without changing the main program code of the metering device; and
performing metering operations on the metering device according to the main program code and the virtual option board, wherein the metering operations are performed by accessing the main program code directly from the at least one block of the flash memory in the microcontroller and accessing, via an application program interface, the virtual option board from the at least one other block of flash memory in the microcontroller.

2. The method of claim 1, wherein the virtual option board comprises code that implements a communication protocol.

3. The method of claim 1, wherein the virtual option board corresponds to a customer-specific request for a metering option on the metering device.

4. The method of claim 1, wherein the virtual option board corresponds to a market in which the metering device is configured to be used.

5. The method of claim 1, wherein said storing the virtual option board as firmware in at least one other block of the flash memory in the microcontroller of the metering device is performed during a manufacturing process.

6. The method of claim 1, further comprising validating an integrity of the virtual option board before said performing the metering operations on the metering device.

7. The method of claim 6, wherein the integrity of the virtual option board is validated using the application program interface.

8. The method of claim 1, wherein the main program code and the virtual option board are developed independently.

9. The method of claim 1, wherein said performing metering operations on the metering device according to the main program code and the virtual option board further comprises recognizing the presence of the virtual option board using the application program interface.

10. The method of claim 1, wherein said storing the virtual option board is performed during a manufacturing process or as an update after the metering device has been installed.

11. A metering device comprising:
a microcontroller configured to perform metering operations on the metering device according to a main program code and a virtual option board;
a first block of flash memory stored in the microcontroller, wherein the main program code is stored as firmware in the first block of flash memory, and wherein the main program code is configured to implement a base level of functionality in the metering device; and
a second block of flash memory stored in the microcontroller, wherein the virtual option board is stored as firmware in the second block of the flash memory, and wherein the virtual option board virtually implements a function of an option board, wherein the virtual option board is stored without changing the main program code of the metering device, and wherein the microcontroller is further configured to access the virtual option board via an application program interface.

12. The metering device of claim 11, wherein the virtual option board comprises a communication protocol.

13. The metering device of claim 11, wherein the virtual option board corresponds to a customer-specific request for a metering option on the metering device.

14. The metering device of claim 11, wherein the virtual option board corresponds to a market in which the metering device is configured to be used.

15. The metering device of claim 11, wherein the virtual option board is stored as firmware in the second block of the flash memory during a manufacturing process.

16. The metering device of claim 11, wherein the microcontroller is further configured to validate an integrity of the virtual option board.

17. The metering device of claim 16, wherein the microcontroller is further configured to use the application program interface to validate the integrity of the virtual option board.

18. The metering device of claim 11, wherein the main program code and the virtual option board are developed independently.

19. The metering device of claim 11, wherein the microcontroller is further configured to recognize the virtual option board using the application program interface.

20. The metering device of claim 11, wherein the virtual option board is stored as a default virtual option board or as an updated virtual option board.
